(19) United States
(12) Patent Application Publication
(10) Pub. No.: US 2025/0291396 A1
(43) Pub. Date: Sep. 18, 2025

(54) SIDEBAND MANAGEMENT OF PERIPHERAL DEVICE POWER, PERFORMANCE AND OPTIMIZATION

(71) Applicant: DELL PRODUCTS L.P., Round Rock, TX (US)

(72) Inventors: Balasingh Samuel, Round Rock, TX (US); Mitchell Markow, Hutto, TX (US)

(21) Appl. No.: 18/603,535

(22) Filed: Mar. 13, 2024

(51) Int. Cl. G06F 1/26

(52) U.S. Cl. CPC G06F 1/266

(57) ABSTRACT

An information handling system includes a peripheral device to provide an optimization setting. The system manages the optimization setting when in a powered state. A baseboard management controller manages the optimization setting when the system is in an unpowered state.

### FIELD OF THE DISCLOSURE

This disclosure generally relates to information handling systems, and more particularly relates to providing sideband management of peripheral device power, performance, and optimization in an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may include a peripheral device to provide an optimization setting. A processor may manage the optimization setting when the processor is in a powered state, and a baseboard management controller may manage the optimization setting when the processor is in an unpowered state.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an information handling system according to an embodiment of the present disclosure;

FIG. 2 is a flowchart illustrating a method for providing sideband management of peripheral device power, performance, and optimization in an information handling system according to an embodiment of the present disclosure: and

FIG. 3 is a block diagram illustrating a generalized information handling system according to another embodiment of the present disclosure;

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

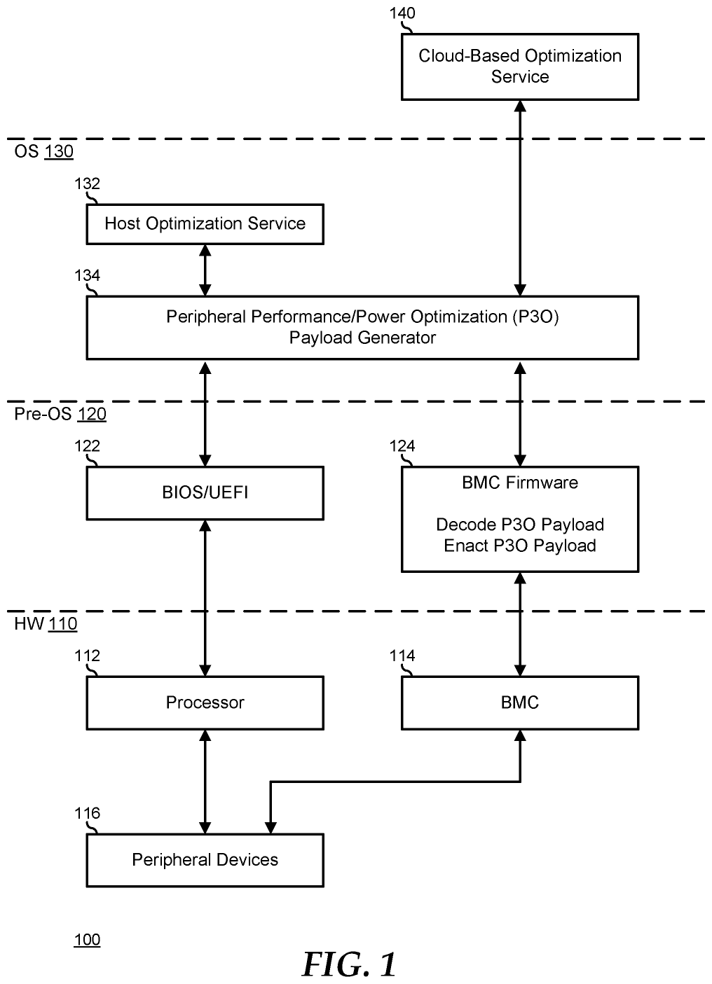

FIG. 1 illustrates an information handling system 100. Information handling system 100 includes a hardware layer 110, a pre-operating system (pre-OS) layer 120, and an OS layer 130, and is connected to a cloud that includes a cloud-based optimization service 140. Hardware layer 110 includes a processo112, a baseboard management controller (BMC) 114, and peripheral devices 116. Processor 112 may be understood to represent one or more central processing units (CPUs), controllers, or the like, and associated processing elements that operate to instantiate a host processing environment (that is, various elements of pre-OS layer 120 and OS layer 130, as described below) on information handling system 100. BMC 114 may be understood to represent one or more CPUs, controllers, or the like, and associated processing elements that operate to instantiate a management environment on information handling system 100 (that is, various elements of pre-OS layer 120 and OS layer 130, as described below).

Peripheral devices 116 represent various hardware elements that are provided in information handling system 100 that provide various functionalities or features that are not typically associated with the core processing functionality of processor 112. Peripheral devices 116 may represent various hardware elements that are provided “down,” that is, fabricated on a printed circuit board (PCB) of information handling system 100. For example, a hardware element that is down on a PCB of information handling system 100 may include integrated network interface controllers, audio controllers, video or graphics controllers, or the like. Peripheral devices 116 may further represent various hardware elements that can be installed into the PCB of information handling system 100 or removed from the PCB as needed or desired. For example, a hardware element that can be installed or removed from information handling system 100 may include stand-alone network interface cards (NICs), audio cards, video or graphics cards, or the like. Peripheral devices 116 are connected to processor 112 and BMC 114 via one or more data communication interfaces provided within hardware 110.

Pre-OS level 120 includes Basic Input/Output System (BIOS)/Universal Extensible Firmware Interface (UEFI) firmware 122 and BMC firmware 124. BIOS/UEFI 122 represents code operable to detect the elements of hardware 110, and particularly of processor 112 and peripheral devices 116, to provide drivers initialize the elements, and to access the elements during run time operations. BMC firmware 124 represents code operable to detect the elements of hardware 110, and particularly of BMC 114, to provide drivers initialize the elements, and to access the elements during run time operations. The code associated with BIOS/UEFI 122 and with BMC firmware 124 is typically stored on non-volatile memory devices associated with processor 112 and BMC 114, respectively. However, in operation, pre-OS level 120 may represent pre-OS operating environments instantiated on processor 112 for BIOS/UEFI 122, and on BMC 114 for BMC firmware 124.

OS level 130 includes a host optimization service 132 and a peripheral performance, power, and optimization (P3O) payload generator 134, as described below. OS level 130 may include a host OS, a service OS, and a BIOS/BMC interface, as needed or desired. A host OS 132 may represent an operating system that is instantiated on processor 112 and that is launched by BIOS/UEFI 122 to provide an operating environment to perform the functions and features associated with the typical use of information handling system 100. For example, a host OS may provide an environment that permits a user of information handling system 100 to launch programs and applications to perform desired functions, as needed or desired. In another example, a host OS may represent a commercial operating system, such as a Windows OS, a Linux OS, or the like, or may represent a dedicated operating system associated with a particular controller or usage model, as needed or desired. A service OS may represent an operating environment that is instantiated on BMC 114 to provide a user interface to the functions and features of the BMC through a network connected mechanism. In particular, a service OS may permit a technician who is remote from information handling system 100 to access BMC 114. A BIOS/BMC interface may provide a bridge between the operating environment established on processor 112 and the operating environment established on BMC 114.

Host optimization service 132 represents an in-band module, that is a module instantiated by processor 112 in the host OS, that evaluates the operating conditions on information handling system 100, and the operational capabilities of the elements of hardware 110, and that manages the operating states of the elements to achieve various policy aims for the overall operation of the information handling system. In particular host optimization service 132 acquires functional descriptions of the operational capabilities of the elements of hardware 110 in various operational states, and directs the elements to implement various capabilities depending upon the detected operating conditions. The operating conditions may be based upon an environmental condition, such as whether information handling system 100 is being powered by an AC adaptor or by a battery, whether a device operating temperature is above or below a threshold, whether an ambient noise level is above or below a threshold, whether an ambient brightness is above or below a threshold, or the like.

The operating condition may further be based upon a user defined condition, such as a user selected operating mode like low-power operation, high-performance operation, battery-longevity operation, low-acoustics operation, cool operation, or the like. Then, based upon the particular operating conditions, host optimization service 132 operates to adjust the performance characteristics of the elements of hardware 110 to best meet the operating conditions. Examples of performance characteristics of the elements of hardware 110 may include performance characteristics for processor 112, such as operating voltage or frequency, core-type affinity, thread count, or other processor characteristics, performance characteristics for peripheral devices 116, such as monitor operating modes, bandwidth limits, or streaming modes, storage or network controller settings, video settings, and the like.

Cloud-based optimization service 140 may be understood to operate similarly to host optimization service 132. Additionally, cloud-based optimization service 140 may be understood to operate to evaluate the placement of workloads within the ecosystem, determining that some workloads are more suitably instantiated with the cloud, while other workloads are more suitably instantiated on information handling system 100. In a particular case, cloud-based optimization service 140 may operate to provide resource allocations for workloads instantiated on information handling system 100, such as CPU or memory bandwidth utilization, thread limits, network bandwidth, or the like.

It has been understood by the inventors that the operations of host optimization service 132 and of cloud-based optimization service 140 provide condition-based and policy-based optimizations for the elements of hardware 110 and the placement and resourcing of workloads on information handling system 100, as needed or desired. However because host optimization service 132 is instantiated by processor 112, and cloud-based optimization service 140 is typically accessed via a network interface, the host optimization service and the cloud-based optimization service are typically only available when information handling system 100 is powered on (such as in the S0 state). Thus, in various low-power states, such as the Modern Standby state, the optimization activities of host optimization service 132 and of cloud-based optimization service 140 are not typically available to optimize the operations of information handling system 100.

Information handling system 100 operates to implement the optimizations of host optimization service 132 and of cloud-based optimization service 140 in various low-power states, such as the Modern Standby state. In particular, P3O payload generator 134 operates to provide information related to the P3O capabilities of peripheral devices 116 to host optimization service 132 and to cloud-based optimization service 140. Such P3O information may be obtained during the boot up phase of operation of information handling system 100, such as during a Power On Self Test (POST) operation. The P3O information may be determined based upon, for example, the settings in a power management table, such as an ACPI table, or the like. Further sources of P3O information may include BMC 114. BMC 114 may operate out of band from processor 112 to determine the P3O capabilities of peripheral devices 116, and may provide the P3O information to P3O payload generator 134 during the boot up phase of operation of information handling system 100.

When host optimization service 132 and cloud-based optimization service 140 receive the P3O information, the host optimization service and the cloud-based optimization service each operate to create optimized states for peripheral devices 116 in various operating conditions of information handling system 100 under the various optimization policies. For example, host optimization service 132 may provide optimized states for peripheral devices 116 for power-on operations (such as the S0 state) under each of 1) a low-power operation policy, 2) a high-performance operation policy, 3) a battery-longevity operation policy, 4) a low-acoustics operation policy, and 5) a cool operation policy, and further provide optimized states for the peripheral devices for reduced-power operation (such as the Modern Standby state), for a total of ten (10) optimized states. Cloud-based optimization service 140 may likewise provide optimized states for the workloads instantiated on information handling system 100. For example a particular workload may be instantiated on information handling system 100 for power-on operations, and may be suspended for reduced-power operations. On the other hand, another workloads may be migrated from information handling system 100 to the cloud for reduced-power operations.

In a particular embodiment, during power-on operations of information handling system 100, host optimization service 132 and cloud-based optimization service 140 may operate in-band to implement the various optimizations to peripheral devices 116, depending on the selected operating policy. Further during power-on operations, for example during the boot up phase of operation of information handling system 100, host optimization service 132 and cloud-based optimization service 140 provide optimization information related to each of the optimization states to P3O payload generator 134. P3O payload generator 134 then operates to create one or more P3O payload that encapsulates the optimization information for the optimization states, and communicates the P3O payloads to BMC 114.

In a particular embodiment, during power-on operations of information handling system 100, BMC 114 then operates out-of-band to implement the various optimizations to peripheral devices 116, depending on the selected operating policy. BMC 114 may remove the necessity of dedicating processing resources of processor 112 to the management of the optimization states of peripheral devices 116, offloading the management of the optimization states of the peripheral devices to the BMC. During reduced-power operations of information handling system 100, BMC 114 operates out-of-band to implement the various optimizations to peripheral devices 116, depending on the selected operating policy. In this way, the optimization advantages as provided by host optimization service 132 and cloud-based optimization service 140 are extended to cover the reduced-power operations of information handling system 100. Further, BMC 114 operates to change the operating policies as needed or desired. For example, consider a case with information handling system 100 transitions from power-on operations to reduced power operations due to passage of a duration of inactivity from a user of the information handling system. In this case, BMC 114 may operate to turn off a monitor in accordance with a particular reduced-power operation policy, and then later to turn of processor 112 in accordance with another reduced-power operation policy after a duration of time.

In a particular embodiment, P3O payload generator 134 operates to sign the P3O payloads with a certificate to protect the payloads from malicious software attacks. The P3O payloads may further be versioned to extend future capabilities. An example P3O payload is shown below:

P3O Payload

| | | | | | | | | |
|---|---|---|---|---|---|---|---|---|
| ID | User | Ver- | Time | Size | Trigger | Payload | Hash | Signature |
| | ID | sion | Stamp | | | | | |

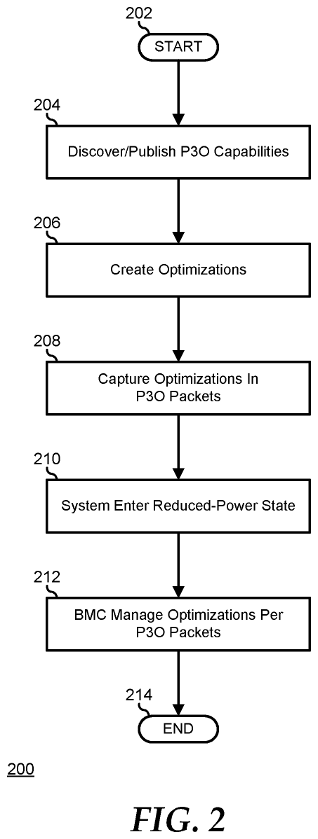

FIG. 2 illustrates a method 200 for providing sideband management of peripheral device power, performance, and optimization in an information handling system, starting at block 202. The P3O capabilities of the peripherals in an information handling system are discovered and published in block 204. An optimization service creates optimization states for various operation policies in block 206. The optimization states are captured in P3O packets and provided to a BMC in block 208. The information handling system enters a reduced-power state in block 210, and the BMC manages the optimizations based upon the P3O packets in block 212. The method ends in block 214.

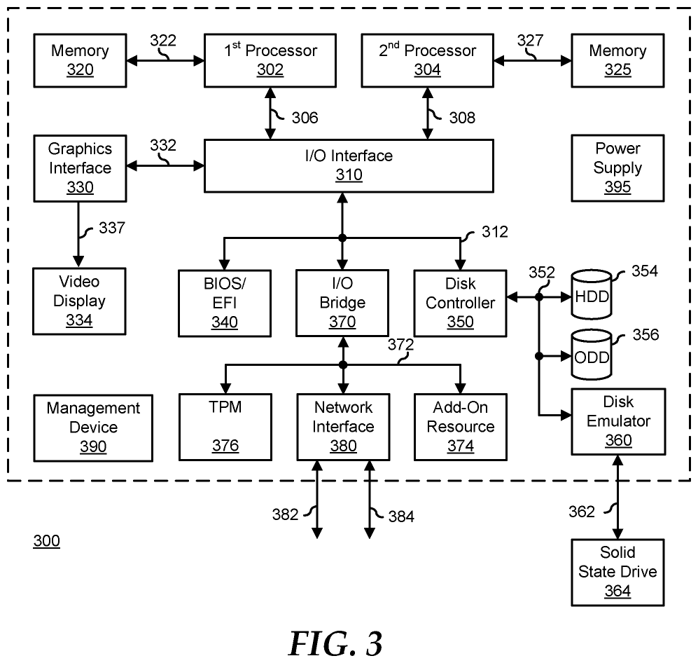

FIG. 3 illustrates a generalized embodiment of an information handling system 300 similar to information handling system 300. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below, and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 362, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 362, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332, and provides a video display output 336 to a video display 334. In a particular embodiment, information handling system 300 includes separate memories that are dedicated to each of processors 302 and 304 via separate memory interfaces. An example of memories 320 and 330 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 1394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312, or can be a different type of interface. As such, I/O bridge 370 extends the capacity of I/O channel 312 where peripheral interface 372 and the I/O channel are of the same type, and the I/O bridge translates information from a format suitable to the I/O channel to a format suitable to the peripheral channel 372 where they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300. Management device 390 can operate off of a separate power plane from the components of the host environment so that the management device receives power to manage information handling system 300 where the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system, comprising:
a peripheral device configured to provide an optimization setting;
a processor configured to manage the optimization setting when the processor is in a powered state; and
a baseboard management controller configured to manage the optimization setting when the processor is in an unpowered state.

2. The information handling system of claim 1, wherein the processor is further configured to instantiate an optimization service.

3. The information handling system of claim 2, wherein the optimization service is configured to determine an optimization profile for the optimization setting.

4. The information handling system of claim 3, wherein the processor is further configured to communicate the optimization profile to the baseboard management controller.

5. The information handling system of claim 4, wherein the processor and the baseboard management controller manage the optimization setting based on the optimization profile.

6. The information handling system of claim 3, wherein the optimization profile is based on an environmental condition of the information handling system.

7. The information handling system of claim 6, wherein the environmental condition includes at least one of a power source for the information handling system, a device operating temperature, an ambient noise level, and an ambient brightness.

8. The information handling system of claim 3, wherein the optimization profile is based on an operating condition of the information handling system.

9. The information handling system of claim 8, wherein the operating mode includes at least one of a low-power mode, a high-performance mode, a battery-longevity mode, a low-acoustics mode, and a cool mode.

10. The information handling system of claim 1, wherein the optimization setting includes a processor performance setting.

11. A method, comprising:
providing, in an information handling system, a peripheral device configured to provide an optimization setting;
managing, by a processor of the information handling system, the optimization setting when the processor is in a powered state; and
managing, by a baseboard management controller of the information handing system, the optimization setting with the processor is in an unpowered state.

12. The method of claim 11 further comprising instantiating, by the processor, an optimization service.

13. The method of claim 12 further comprising determining, by the optimization service, an optimization profile for the optimization setting.

14. The method of claim 13 further comprising communicating, by the processor, the optimization profile to the baseboard management controller.

15. The method of claim 14 further comprising managing, by the processor and the baseboard management controller, the optimization setting based on the optimization profile.

16. The method of claim 13, wherein the optimization profile is based on an environmental condition of the information handling system.

17. The method of claim 16, wherein the environmental condition includes at least one of a power source for the information handling system, a device operating temperature, an ambient noise level, and an ambient brightness.

18. The method of claim 13, wherein the optimization profile is based on an operating condition of the information handling system.

19. The method of claim 18, wherein the operating mode includes at least one of a low-power mode, a high-performance mode, a battery-longevity mode, a low-acoustics mode, and a cool mode.

20. An information handling system, comprising:
a peripheral device configured to provide an optimization setting;
a processor configured to generate an optimization profile for the optimization setting, and to manage the optimization setting based on the optimization profile when the processor is in a powered state; and
a baseboard management controller, wherein the processor is further configured to provide the optimization profile to the baseboard management controller, and the baseboard management controller is configured to manage the optimization setting based on the optimization profile when the processor is in an unpowered state.
